(19) United States
(12) Patent Application Publication
(10) Pub. No.: US 2012/0058651 A1
(43) Pub. Date: Mar. 8, 2012

(54) CONNECTOR HAVING AN IMPROVED COVER

(75) Inventors: CHIEN-CHIUNG WANG, New Taipei (TW); XUE-LIANG ZHANG, Kunshan (CN); QING-MAN ZHU, Kunshan (CN)

(73) Assignee: HON HAI PRECISION INDUSTRY CO., LTD., New Taipei (TW)

(21) Appl. No.: 13/226,700

(22) Filed: Sep. 7, 2011

(30) Foreign Application Priority Data
Sep. 8, 2010 (CN) 201020523354.1

(51) Int. Cl. H01R 12/00

(52) U.S. Cl. 439/76.1

(57) ABSTRACT

A connector (100) includes a cover (20) stamped from a metal sheet having a first cover portion (21) and a second cover portion (22) engaging with each other, and a printed circuit board (PCB) (10) having a notch (101). The second cover portion has two opposite side walls (224) and a respective protrusion (2242) extending inwardly from each of the side walls to support the PCB upwardly. The first cover portion has a lower opening (2150) engaging the PCB downwardly. Said protrusions and the opening holding the PCB from both an up-to-bottom direction and a right-to-left direction. One of the first cover portion and the second cover portion having a rib (2142) inserted into the notch for preventing the PCB from moving along a front-to-back direction.

### BACKGROUND OF THE INVENTION

1. Field of the Invention

The present invention relates to a connector, more particularly relates to a SFP (Small Form-Factor Pluggable) connector used for high frequency signal transmission.

2. Description of Related Art

U.S. Pat. No. 7,294,004, issued to Pineda on Nov. 13, 2007, discloses a connector having a cover and a printed circuit board (PCB) engaged with the cover. The cover includes a first cover and a second cover coupling to the first cover. The PCB has at least one through hole. A screw is engaged into the through hole for mounting the PCB onto the second cover. On the other hand, the circuit on the PCB should be far away from the through hole to avoid shorting with the screw.

Hence, a connector having an improved cover is desired.

### SUMMARY OF THE INVENTION

Accordingly, an object of the present invention is to provide a connector including a cover and a PCB assembled therein, the cover includes a first cover and a second cover. The second cover has two opposite side walls, and a pair of protrusions respectively extending inwardly from the side walls to support the PCB upwardly, the first cover having a downward opening locking the PCB downwardly, said protrusions and the opening holding the PCB from up-to-bottom direction and right-to-left direction, one of the first cover and second cover having a rib inserted into the notch for preventing the PCB from moving along a front-to-back direction.

The PCB 10 could be assembled securely in the cover when the first cover is assembled to the second cover. The connector has an improved structure to fix the PCB 10 easily, and no screw is needed.

Other objects, advantages and novel features of the invention will become more apparent from the following detailed description when taken in conjunction with the accompanying drawings.

### BRIEF DESCRIPTION OF THE DRAWINGS

FIG. 1 is an assembled perspective view showing a connector assembly including a cage and a connector of the present invention;

FIG. 2 is a perspective view showing the connector separated from the cage as shown in FIG. 1;

FIG. 3 is a partially exploded perspective view showing the connector as shown in FIG. 2;

FIG. 4 is an exploded perspective view showing the connector as shown in FIG. 2;

FIG. 5 is another exploded perspective view showing the connector as shown in FIG. 2 taken from another aspect;

FIG. 6 is an enlarged view showing the elastic arm marked by a circle in FIG. 3; and

FIG. 7 is a cross-sectional view of the connector and a cage in a latched position, taken along line 7-7 of FIG. 1.

### DETAILED DESCRIPTION OF THE PREFERRED EMBODIMENT

Reference will now be made in detail to the preferred embodiment of the present invention.

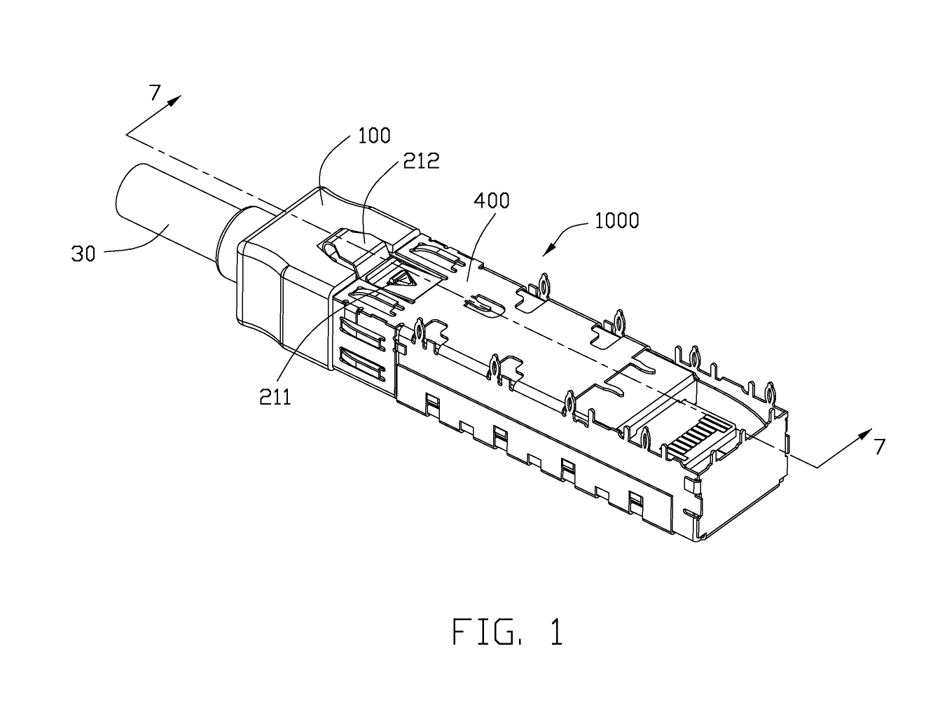

Referring to FIG. 1, a connector assembly 1000 includes a cage 400 and an electrical connector 100 inserted in the cage 400. The connector 100 has a rear portion connecting with a cable 30 and a front portion mating with a receptacle connector (not shown).

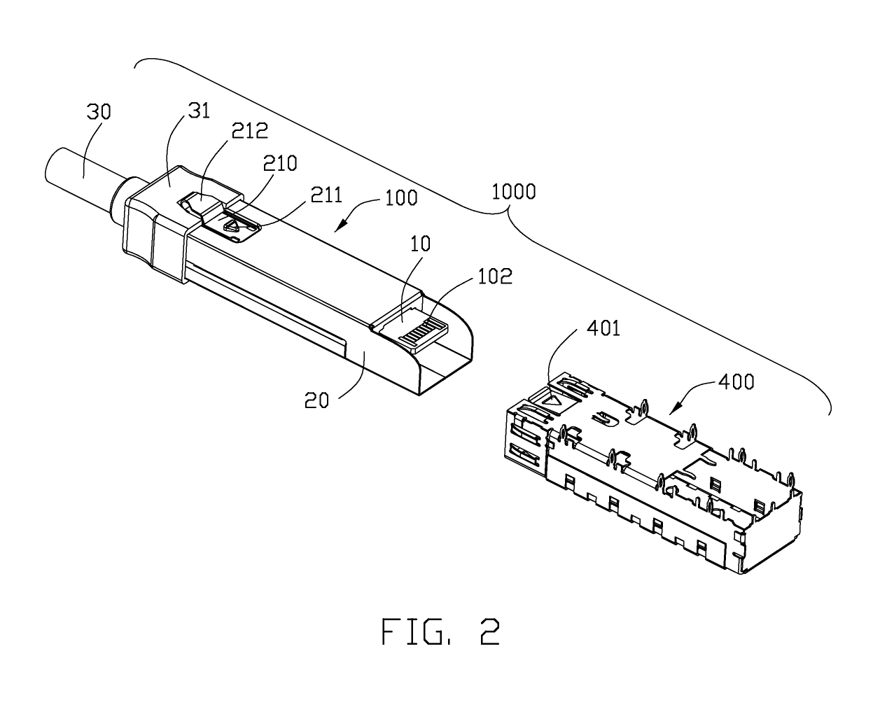

Referring to FIG. 2, the connector 100 includes an internal printed circuit board (PCB) 10, a cover 20 stamped from a metal sheet, and a dielectric cover 31 attached to the rear portion of the cover 20. The PCB 10 has a front mating portion 102 protruding out of the cover 20 for mating with the receptacle connector, and a rear soldering portion for soldering the cable 30.

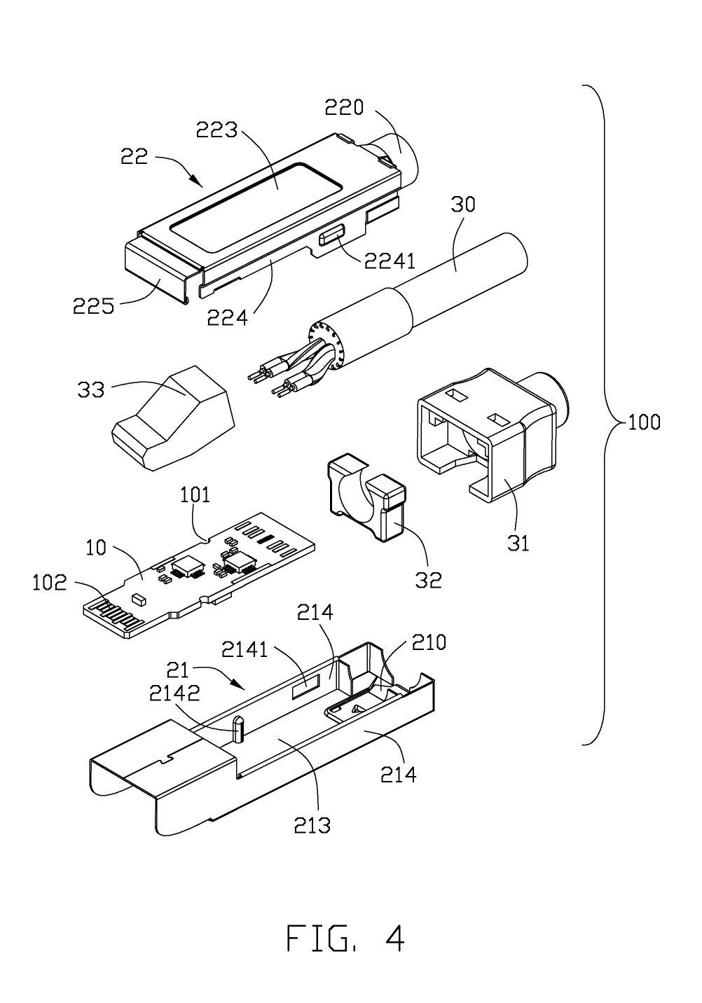

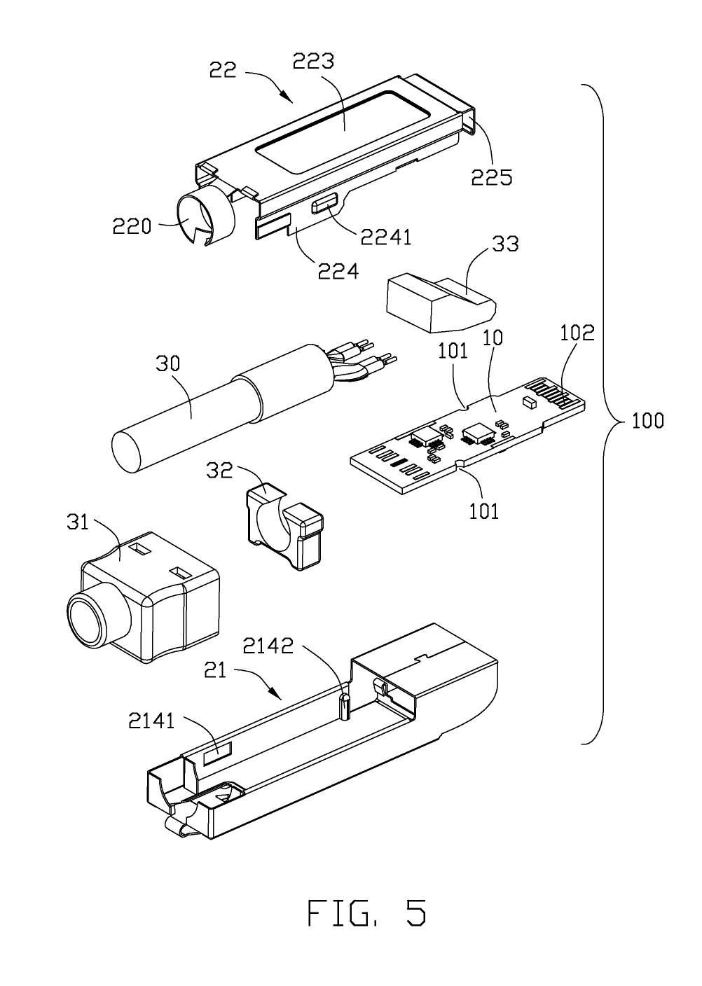

Referring to FIGS. 2 to 5, the connector 100 further includes a molded block 33 mounted to the rear portion of the PCB 10. The molded block 33 encloses the end of the cable 30 to protect a soldering joint area between the cable 30 and the PCB 10. The molded block 33 may alternatively be supported by the cover 20 to securely fix the PCB. The connector 100 optionally includes a conductive foam 32 filled in the back of the dielectric cover 31 to reduce the crosstalk around the connector.

The cover 20 includes a first cover portion 21 and a second cover portion 22 cooperating with each other. The second cover portion 22 further includes a ring 220 extending from the rear portion of the second cover portion 22. The ring 220 clips the cable 30 for improving the retention force between the cable 30 and the connector 100. The ring 220 also could be defined on the first cover portion 21. The dielectric cover 31 attaches to the rear portion of the cover 20 and wraps the ring 220.

The first cover portion 21 includes a top wall 213 having two opposite side edges and a front edge. The first cover portion 21 further includes two peripheral walls 214 extending vertically from the side edges of the top wall 213. The peripheral walls 214 are generally parallel with each other. The first cover portion 21 further has a front upper wall 215 vertically extending from the front edge of the top wall 213. The front upper wall 215 defines an opening 2150 for engaging the PCB 10 downwardly along a first direction (up-to-bottom direction) to prevent the PCB 10 from moving along a second direction (right-to-left direction). The first cover portion 21 has at least one groove 2141 formed at the rear portion of the peripheral wall 214. The first cover portion 21 has a rib 2142 formed at the inner side of the peripheral wall 214. The PCB 10 has a notch 101 defined at a side edge. The rib 2142 is inserted into the notch 101 along a first direction to prevent the PCB 10 from moving along a third direction (front-to-back direction). The first, second and third directions are orthogonal to one another.

The second cover portion 22 includes a bottom wall 223 having two opposite side edges and a front edge. The second cover portion 22 includes two side walls 224 extending vertically from the side edges of the bottom wall 223. The second cover portion 22 has a front lower wall 225 extending vertically from the front edge of the bottom wall 223. Each of the side walls 224 has at least one protrusion 2242 extending inwardly from the side wall 224 for supporting the PCB 10 upwardly.

The front upper wall 215 and the front lower wall 225 shield most of the region around the front portion of the PCB 10 to reduce crosstalk. Each of the two side walls 224 has at least one projection 2241 extending outwardly at the rear portion of the second cover portion 22. The first cover portion 21 locks with the second cover portion 22 at the rear portion by engaging the projection 2241 with the groove 2141. The first cover portion 21 and the second cover portion 22 cab be coupled together by other suitable means well known in this art.

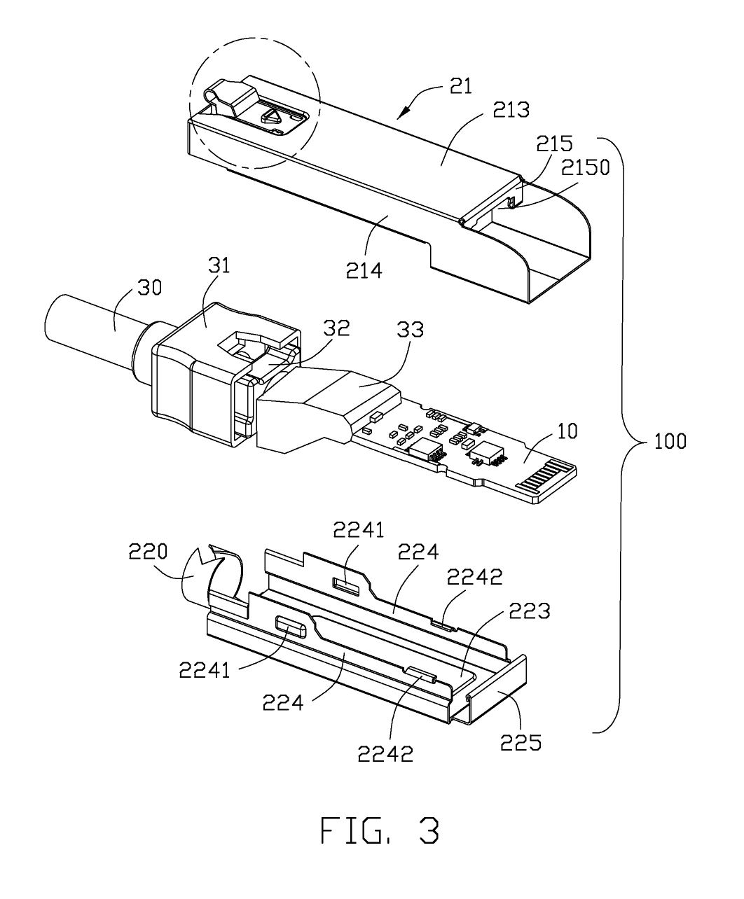

In conjunction with FIGS. 3 to 5, the first cover portion 21 is fastened to the second cover portion 22 at the front portion and locked with the second cover portion 22 at the rear portion. The protrusions 2242 and the opening 2150 holding the PCB 10 from both an up-to-bottom direction and a right-to-left direction. The rib 2142 is locked within the notch 101 of the PCB 10 for preventing the PCB 10 from moving along the front-to-back direction. Consequently, the PCB 10 could be assembled securely in the cover 20 when the first cover portion 21 is assembled to the second cover portion 20. The connector 100 has an improved structure to fix the PCB 10 easily.

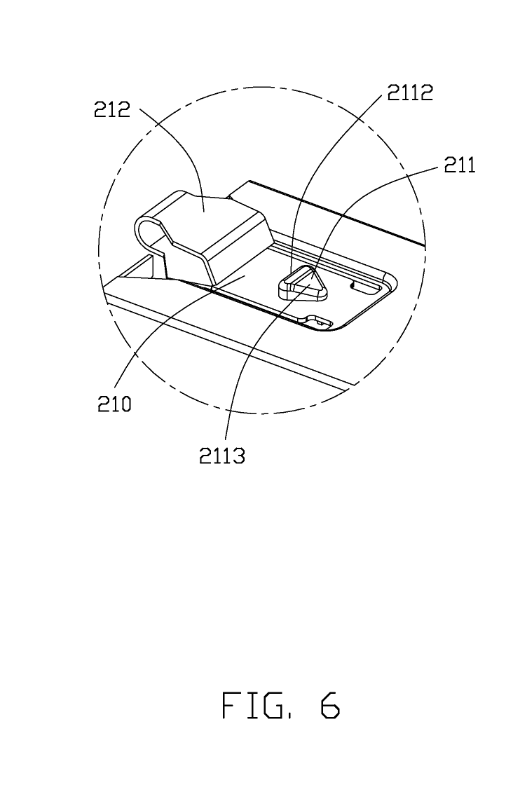

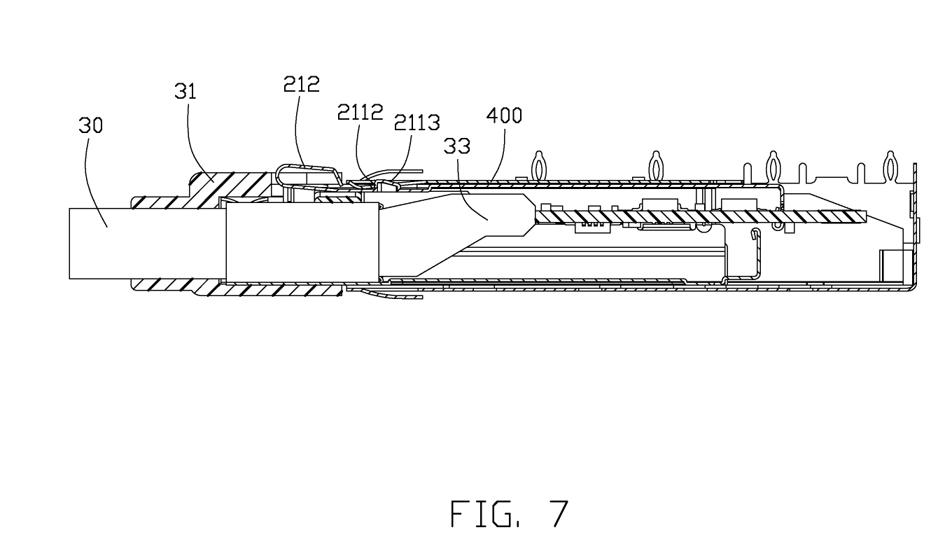

Referring to FIGS. 2, 6, and 7, the first cover portion 21 further has two slits 2101 cut from the top wall 213 by stamping. The top wall 213 therefore forms an integral flexible or elastic arm 210 between the slits 2101. The elastic arm 210 extends backwardly horizontally from the top wall 213 in a cantilever configuration. The elastic arm 210 comprises a front portion connecting to the main part of the top wall 213 and a rear free end portion 2102 against the front portion thereof. The rear free end portion 2102 can move up and down relative to the front portion of the elastic arm 210 by rotating around the front portion. The movement of the rear free end portion 2102 imparts to the elastic arm 210 a resilient returning force. The elastic arm 210 has a tab 211 extending upwardly between the front portion and the rear free end portion 2102, and an operator 212 upward and frontward extending from the end of the rear free end portion 2102. The operator 212 is inturned and adapted for convenient operation by a finger. The elastic arm 210 also could be formed on the second cover portion 22, depending on specific applications. The operator 212 is designed to essentially move inwardly or downwardly, i.e., along the first direction, by a simple pressing action. The cage 400 has a latching hole 401 for receiving the tab 211.

The tab 211 includes a ramp surface 2113 inclining forwardly and downwardly to lead the latching hole 401 mating with the tab 211 when the connector 100 is inserted into the cage 400. The tab 211 is received in the latching hole 401 at a latched position for locking the connector 100 in the cage 400. The tab 211 has a vertically extending resisting surface 2112 to resist against the latching hole 401.

When the operator 212 is depressed downwardly, the tab 211 moves together with the operator 212 downwardly from the latched position to a released position for releasing the connector 100 from the cage 400. The tab 211 returns from the released position back to the latched position via the resilient force provided by the elastic arm 210 once the tab 211 is out of the latching hole 401.

It is to be understood that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A connector, comprising:
a printed circuit board (PCB) having a notch defined at a side edge thereof; and
a cover stamped from a metal sheet and including a first cover portion and a second cover portion engaging with each other, the second cover portion having two opposite side walls and a respective protrusion extending inwardly from each of the side walls to support the PCB upwardly, the first cover portion having a lower opening engaging the PCB downwardly, said protrusions and the opening holding the PCB from both an up-to-bottom direction and a right-to-left direction, one of the first cover portion and the second cover portion having a rib inserted into the notch for preventing the PCB from moving along a front-to-back direction.

2. The connector as claimed in claim 1, wherein said first cover portion has a top wall, two opposite peripheral walls, and a front upper wall downwardly extending from the top wall, and said second cover portion has a bottom wall and a pair of side walls extending from the bottom wall and engaging with the peripheral walls.

3. The connector as claimed in claim 2, wherein said peripheral wall has a groove, and the side wall has a projection engaged with the groove for locking the first cover portion with the second cover portion.

4. The connector as claimed in claim 2, wherein said rib is formed at an inner side of the peripheral wall.

5. The connector as claimed in claim 2, wherein said opening is defined on the front upper wall and open downwardly.

6. The connector as claimed in claim 1, wherein said PCB has a front mating portion for mating with a receptacle connector and a rear portion for soldering a cable.

7. The connector as claimed in claim 6, further including a molded block enclosing the rear soldering portion and the end of the cable.

8. The connector as claimed in claim 6, further including a ring positioned at the rear portion of the cover for clipping the cable.

9. An electrical connector comprising:
a cover device including a first metallic cover and a second metallic cover assembled to each other in a vertical direction to commonly define a receiving space to communicate with an exterior in a front-to-back direction perpendicular to said vertical direction;
a printed circuit board received in the receiving space;
a cable connected to the printed circuit board;
the first cover defining a first base all, a pair of first side walls extending from two opposite first side edges of the first base wall, and a first front wall extending from a front end edge of the first base wall;
the second cover defining a second base wall, a pair of second side walls extending from two opposite second side edges of the second base wall, and a second front wall extending from a front end edge of the second base wall; and
fastening devices formed on both the first side walls and the second side walls and overlapped with each other in a transverse direction perpendicular to both said vertical direction and said front-to-back direction to secure the first cover and the second cover together; wherein
either the first side walls or the second side walls define protrusions to support the printed circuit board; wherein
the first front wall and the second front wall commonly define a front opening viewed along the front-to-back direction, which snugly allows the printed circuit board to extend therethrough.

10. The electrical connector as claimed in claim 9, wherein either the first side walls or the second side walls define ribs to be received in corresponding notches of the printed circuit board to restrict movement of the printed circuit board relative to the cover device along the front-to-back direction.

11. The electrical connector as claimed in claim 9, wherein the first front wall and the second front wall are essentially offset from each other in the front-to-back direction with a gap.

12. The electrical connector as claimed in claim 9, wherein the first cover further includes a U-shaped structure unitarily formed on the distal front end and located in front of the corresponding first front wall and the second front wall to shield a front end region of the printed circuit board.

13. The electrical connector as claimed in claim 12, wherein said U-shaped structure is located at a same level with the second cover.

14. The electrical connector as claimed in claim 12, wherein the first cover is further equipped with a triangular locking tab thereon.

15. The electrical connector as claimed in claim 14, wherein the second cover is equipped with a ring clamping the cable.

16. The electrical connector as claimed in claim 12, wherein the first side walls cover the corresponding second side walls.

17. The electrical connector as claimed in claim 9, wherein a rear edge region of the printed circuit board is unified with the cable via an insulative block which protects joints thereof.

18. An electrical connector comprising:
a cover device including a first metallic cover and a second metallic cover assembled to each other in a vertical direction to commonly define a receiving space to communicate with an exterior in a front-to-back direction perpendicular to said vertical direction;
a printed circuit board received in the receiving space;
a cable connected to the printed circuit board;
the first cover defining a first base all, a pair of first side walls extending from two opposite first side edges of the first base wall, and a first front wall extending from a front end edge of the first base wall;
the second cover defining a second base wall, a pair of second side walls extending from two opposite second side edges of the second base wall, and a second front wall extending from a front end edge of the second base wall; and
fastening devices formed on both the first side walls and the second side walls to secure the first cover and the second cover together; wherein
the first front wall and the second front wall commonly define a front opening viewed along the front-to-back direction, which snugly allows the printed circuit board to extend therethrough; wherein
the first cover further includes a U-shaped structure unitarily formed on the distal front end and located in front of the corresponding first front wall and the second front wall to shield a front end region of the printed circuit board.

19. The electrical connector as claimed in claim 18, wherein said U-shaped structure is located at a same level with the second cover.

20. The electrical connector as claimed in claim 18, wherein the first cover is further equipped with a triangular locking tab thereon.
